(19) United States
(12) Patent Application Publication
(10) Pub. No.: US 2009/0086260 A1
(43) Pub. Date: Apr. 2, 2009

(54) FAX APPARATUS AND DATA MANAGEMENT METHOD THEREOF

(75) Inventor: Eun-sook Shin, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/197,683

(22) Filed: Aug. 25, 2008

(30) Foreign Application Priority Data
Sep. 28, 2007 (KR) 2007-98039

(51) Int. Cl. G06F 3/12

(52) U.S. Cl. 358/1.15

(57) ABSTRACT

A data management method of a fax apparatus, the data management method includes setting a storage option of fax data, receiving at least one fax data, and storing at least one received fax data as a single file according to the set storage option.

### CROSS-REFERENCE TO RELATED APPLICATIONS

This application claims priority under 35 U.S.C. § 119(a) from Korean Patent Application No. 10-2007-0098039, filed on Sep. 28, 2007, in the Korean Intellectual Property Office, the disclosure of which is incorporated herein by reference in its entirety.

### BACKGROUND OF THE INVENTION

1. Field of the Invention

The present general inventive concept relates to a fax apparatus and a data management method thereof, and more particularly, to a fax apparatus to store and manage received fax data, and a data management method thereof.

2. Description of the Related Art

A fax apparatus receives fax data from a sender and stores it as a file. Thus, a user may search the stored fax data when necessary. The received fax data is managed as a single job, and stored as a single file. If several fax data are received at different times, they are stored as several files corresponding to the number of the data.

If each fax data is managed as an individual file, a user must individually execute the stored file and check the content thereof to search the stored fax data.

That is, even if the fax data which is received from the same sender or received at the same time is managed together, the fax data are stored as individual files, thereby causing inconvenience in checking the content later or in managing the files.

Moreover, even if a user wants to output or retransmit fax data received from a particular sender or at a particular time only, he/she must output or transmit each stored file.

### SUMMARY OF THE INVENTION

The present general inventive concept provides a fax apparatus to manage and use a plurality of fax data more conveniently, and a data management method thereof.

Additional aspects of the present general inventive concept will be set forth in part in the description which follows and, in part, will be obvious from the description, or may be learned by practice of the present general inventive concept.

The foregoing and/or other aspects and utilities of the present general inventive concept may be achieved by providing a data management method of a fax apparatus, the data management method including setting a storage option of fax data, receiving at least one fax data, and storing at least one received fax data as a single file according to the set storage option.

The storing of the fax data as the single file may include updating a prestored file with the received fax data.

The updating of the prestored file may include adding the received fax data to the prestored file.

The updating of the prestored file may include at least one of removing at least one fax data included in the prestored file and changing an order of the fax data.

The updating of the prestored file may include updating the prestored file per page of received fax data.

The prestored file may be set by a user.

The setting of the storage option may include storing at least one fax data received from a same sender number or received at a same time, as a single file.

The setting of the storage option may include setting a format of the stored file.

The data management method may further include displaying the stored file.

The data management method may further include printing all or a part of the fax data stored as the single file according to a user's selection.

The data management method may further include transmitting all or a part of the fax data stored as the single file according to a user's selection.

The foregoing and/or other aspects and utilities of the present general inventive concept may also be achieved by providing a fax apparatus, including a receiver to receive at least one fax data from a sender, a user input unit to receive a storage option of the received fax data, a storage unit to store the received fax data therein, and a controller to control the storage unit to store at least one received fax data as a single file there according to the received storage option of the received fax data.

The controller may update a prestored file with the received fax data.

The controller may update the prestored file by adding the received fax data thereto.

The controller may update the prestored file by at least one of removing at least one fax data among the fax data included in the prestored file and changing an order of the fax data.

The controller may update the prestored file per page of received fax data.

The prestored file may be set by a user.

The storage option may include storage of at least one fax data received from a same sender number or received at a same time, as a single file.

The storage option may include setting a format of the stored file.

The fax apparatus may further include a display unit to display the stored file.

The fax apparatus may further include an output unit to print all or a part of the fax data stored as the single file according to a user's selection.

The fax apparatus may further include a transmitter to transmit all or a part of the fax data stored as the single file according to a user's selection.

The foregoing and/or other aspects and utilities of the present general inventive concept may also be achieved by providing a fax data management system, including a fax data receiving device to receive fax data, an input device to preset a storage option associated with received predetermined fax data, a controller to determine whether the received fax data is the predetermined fax data, and a memory to store the received fax data therein in a first file according to the preset storage option if the received fax data is the predetermined fax data, and to store the received fax data therein in a second file if the received fax data is not the predetermined fax data.

The first file may be a prestored file which includes fax data of at least a first sender.

The second file may be a prestored file which includes fax data of a second sender different than the first sender.

The fax data management system may include a fax data sending unit to transmit fax data from one of the first file and second file to a predetermined receiver.

The foregoing and/or other aspects and utilities of the present general inventive concept may also be achieved by providing a method to manage fax data in a fax apparatus, the method including storing received fax data in a single file according to a preset storage option of predetermined fax data, and outputting at least one predetermined fax data stored in the single file to a selected receiver.

The single file may include more than one fax data of a first sender.

The outputting of the single file may include transmitting at least one fax data of the single file over a wireless network.

The outputting of the single file may include transmitting at least one fax data of the single file over the Internet.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram of a fax apparatus according to an exemplary embodiment of the present general inventive concept; and

FIGS. 2 through 4 are flowcharts to illustrate a data management method of the fax apparatus according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

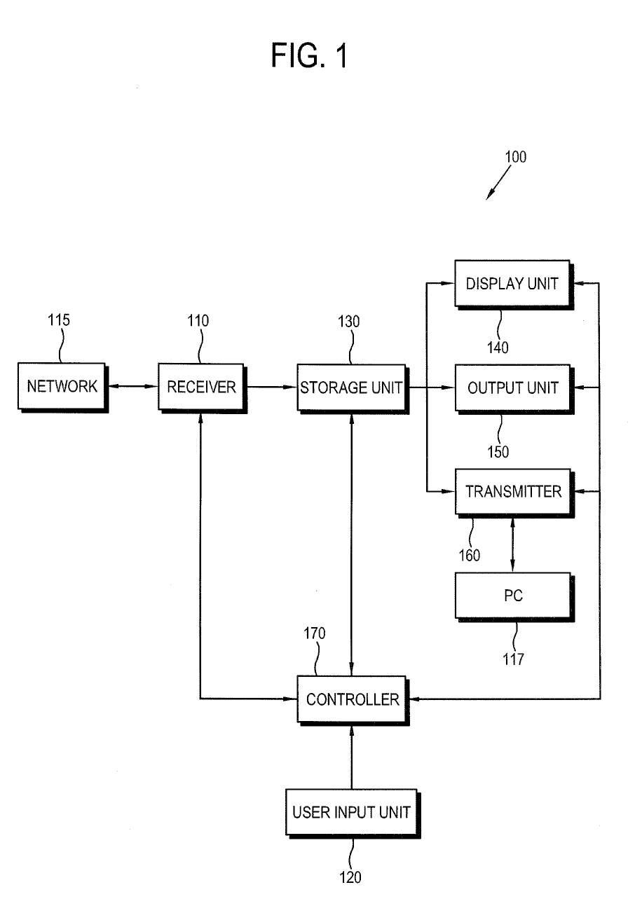

FIG. 1 is a block diagram of a fax apparatus according to an exemplary embodiment of the present general inventive concept. A fax apparatus 100 may include a multi-function device which performs a faxing function or a facsimile machine.

As illustrated therein, the fax apparatus 100 includes a receiver 110, a user input unit 120, a storage unit 130, a display unit 140, an output unit 150, a transmitter 160 and a controller 170.

The receiver 110 receives at least one data (hereinafter, to be called “fax data”) from one or more data senders.

The receiver 110 is connected to a predetermined communication network 115 and receives fax data through fax communication with the network 115 according to control of the controller 170. The receiver 110 may include a modem, a local area network (LAN) interface unit (LIU), a network interface card (NIC), etc., (not illustrated). The network 115 may be a public switched telephone network (PSTN), LAN and/or the Internet.

The user input unit 120, which may be a touch screen display, a plurality of input keys, or an external PC, receives a user's input to transmit a fax and a storage option command to store received fax data. The user input unit 120 may include function keys such as print, fax and scan keys to illustrate functions of the fax apparatus 100, and a plurality of alphanumeric keys to, for example, input fax numbers if the fax function is selected.

The storage option refers to an option to store at least one received fax data as a single file. For example, a user may input a storage option command to store at least one fax data received from a particular sender number or received at particular time, as a single file. The storage option may be set to update one of the fax data stored in the storage unit 130, with received fax data. The user input unit 120 may be used to set any of a plurality of storage options of the fax apparatus 100 according to the user's selection.

The storage unit 130, which may be, for example, a portable, removable memory device, or a permanent memory unit disposed within the fax apparatus 100, stores at least one fax data received by the receiver 110 as a single file according to the one or more storage options set by the user via the user input unit 120.

The file stored in the storage unit 130 may include a file format such as PDF and TIFF and may include various fax data information including sender numbers, sent time and/or date, receiver numbers and received time and/or date. The information about the fax data may be stored and managed in the storage unit 130. The file format of a stored file, such as PDF and TIFF, may be included as a storage option to be set by a user.

Alternatively, the information about the fax data may be stored in another location of the storage unit 130 to be managed as information linked to the stored file instead of being included in the stored file.

The display unit 140 may include a display module (not illustrated) to display fax data stored as a single file, and information about the fax data. The display unit 140 may include various display modules, including a digital light processing (DLP) display, a liquid crystal display (LCD) and a plasma display panel (PDP). The display unit 140 may include a device (e.g. display apparatus, or PC) having an additional display module and connectable to the fax apparatus 100, instead of being included in the fax apparatus 100.

The output unit 150 prints all or a part of the fax data stored as a single file, according to the user's selection.

More specifically, the output unit 150 may print all or a part of at least one fax data included in the single file stored in the storage unit 130. For example, if a particular sender number is associated with a preset storage option, only the latest fax data of a plurality of fax data of that particular sender number which is stored as a single file by the storage option may be selectively printed.

Otherwise, all of the plurality of fax data stored as a single file by the particular storage option may be printed according to the user's selection.

The transmitter 160 transmits all or a part of the fax data stored as the single file through a communication network, which may be the network 115 described above, or to a computer, for example a PC 117, through a USB port (not illustrated), according to user's selection via user input unit 120. The transmitter 160 may include a wired/wireless communication module (not illustrated) to communicate with the communication network, or a connector (not illustrated) to be connected with the USB port. In another embodiment, the transmitter 160 and the receiver 110 may be included within a transceiver unit (not illustrated) which communicates with the network 115, the PC 117 and other external networks or devices (not illustrated).

More specifically, the transmitter 160 may transmit all or a part of at least one fax data included in the single file stored in the storage unit 130. For example, the transmitter 160 may, for a particular receiver number associated with a certain preset storage option, selectively transmit only the latest fax data among a plurality of fax data stored as a single file by the storage option.

The transmitter 160 may otherwise transmit all of the plurality of fax data stored as the single file by the particular storage option, according to the user's selection.

The controller 170 controls the fax apparatus 100 to create a single file corresponding to at least one fax data received through the receiver 110 and to store the single file in the storage unit 130 according to a storage option inputted through the user input unit 120 by the user.

More specifically, the controller 170 determines whether the fax data received through the receiver 110 includes data to be stored according to the preset storage option. If received data is to be stored according to the preset storage option and if the storage unit 130 has stored the file according to the preset storage option, the file (hereinafter, to be called “prestored file”) is updated by the received fax data. If the file associated with the preset storage option is not stored in the storage unit 130, the controller 170 controls the storage unit 130 to create a new file, associated with the preset storage option, in which to store the received fax data.

In this case, the updating of the file may include removing at least one previously stored fax data among the fax data included in the prestored file and/or changing the order of the previously stored fax data, as well as adding the received fax data to the prestored file.

The controller 170 may update the prestored file per page of the received fax data. Parameters associated with the prestored file, such as file name, file size, file format, etc., may be set by a user.

If the controller 170 receives a command through the user input unit 120 to print the stored file, and if the selected file includes at least one fax data, the controller 170 may control the output unit 150 to print all, or a part, of the selected file according to user's selection. For example, depending on the user selected fax data to be stored within a file, the user may select that only a most recent fax data within a file is to be printed, or that only fax data received on one or more dates or times are to be printed, or that only fax data from a particular sender or senders is/are to be printed, etc.

If the controller 170 receives a command through the user input unit 120 to transmit the stored file and if the selected file includes at least one fax data, the controller 170 controls the transmitter 160 to transmit all or a part of the selected file through a communication network or a USB according to the user's selection, as described above.

The controller 170 may control the display unit 140 to display a selected file, the information about the fax data of the selected file, etc.

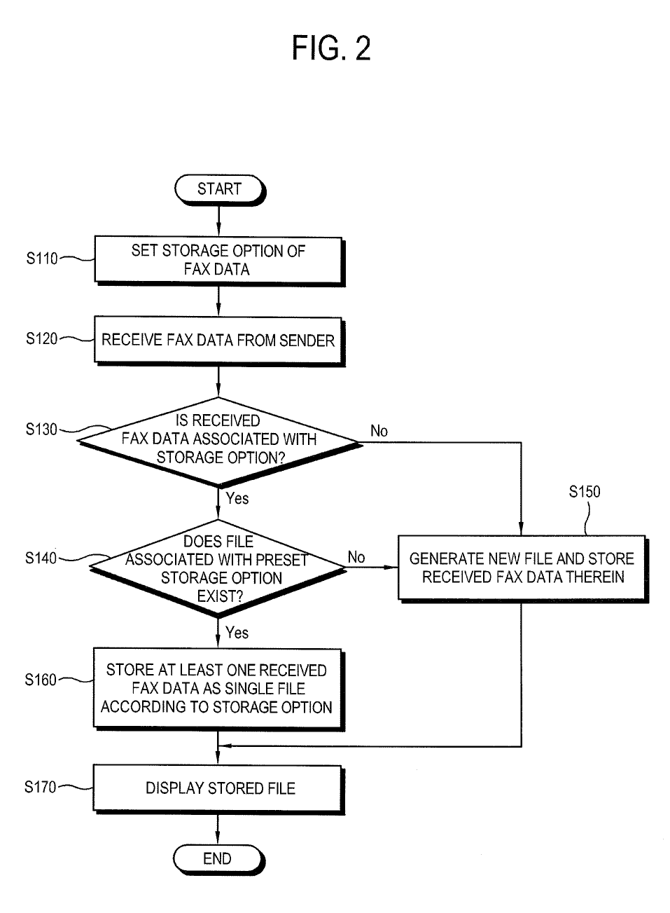

Hereinafter, a control process of an embodiment of the fax apparatus 100 will be described with reference to FIGS. 2 through 4.

As illustrated in FIG. 2, the controller 170 determines the storage option of fax data according to a user's input (operation S110).

The receiver 110 receives the fax data from the sender (operation S120).

The controller 170 determines at operation S120 whether the received fax data includes data to be stored according to the predetermined storage option (operation S130).

If it is determined at operation S130 that the received fax data includes data to be stored according to the preset storage option, the controller 170 determines whether the storage unit 130 has stored a file according to the preset storage option (operation S140).

If it is determined at operation S140 by the controller 170 that a file associated with the preset storage option is stored in the storage unit 130, the controller 170 controls the fax apparatus 100 to store at least one received fax data within the file in the storage unit 130 according to the preset storage option (operation S160).

If it is determined at operation S130 by the controller 170 that the received fax data does not include fax data to be stored according to the preset storage option, the controller 170 controls the storage unit 130 to create a new file in which to store the received fax data associated with the preset storage option therein (operation S150).

If the controller 170 determines at operation S140 that a file associated with the preset storage option is not stored in the storage unit 130, the controller 170 controls the storage unit 130 to create a new file and to store the received fax data therein in the storage unit 130 (operation S150).

The newly created file of operation S150 and the file of operation S160 to which the received fax data is included may be displayed to a user through the display unit 140 or an external display device connected to the fax apparatus 100.

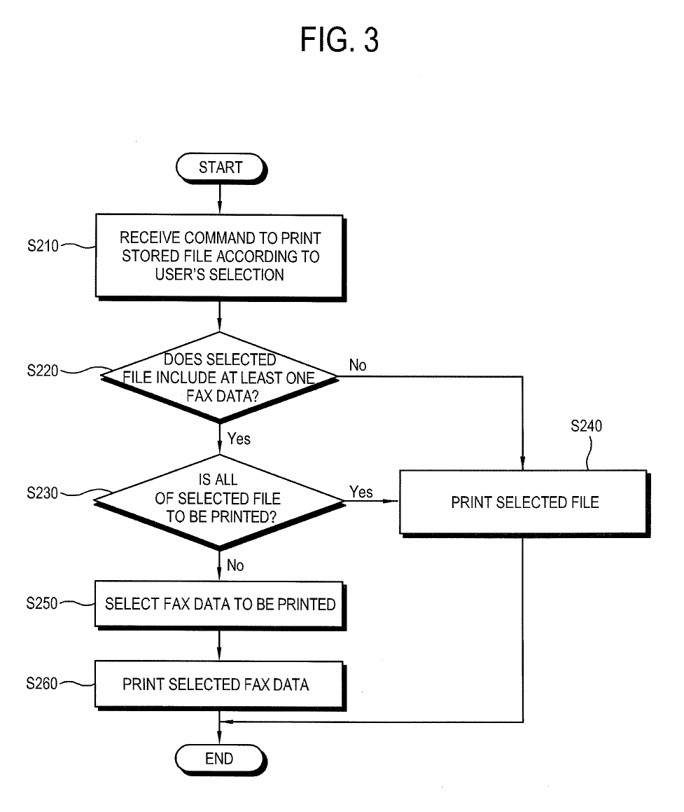

Referring to FIG. 3, the controller 170 may receive a command to print a stored file according to user's selection (operation S210).

The controller 170 may determine whether the file selected at operation S210 includes at least one fax data (operation S220). The controller 170 may control the display unit 140 or the external device connected to the fax apparatus 100 to display the selected file, the information about the fax data of the selected file, etc.

If the selected file includes at least one fax data at operation S220, the controller 170 determines whether to print all, or a part, of the file selected through the user input unit 120 (operation S230).

If it is determined at operation S230 that only part of the selected file is to be printed, at operation S250 the controller 170 selects the fax data to be printed which corresponds to a user print command entered through the user input unit 120.

If it is determined at operation S220 that the selected file does not include at least one fax data, the controller 170 controls the output unit 150 to print the selected file (operation S240).

If it is determined at operation S230 that all of a selected file is to be printed, the controller 170 controls the output unit 150 to print all of the selected file (operation S240).

The controller 170 controls the output unit 150 to print the selected fax data (operation S260).

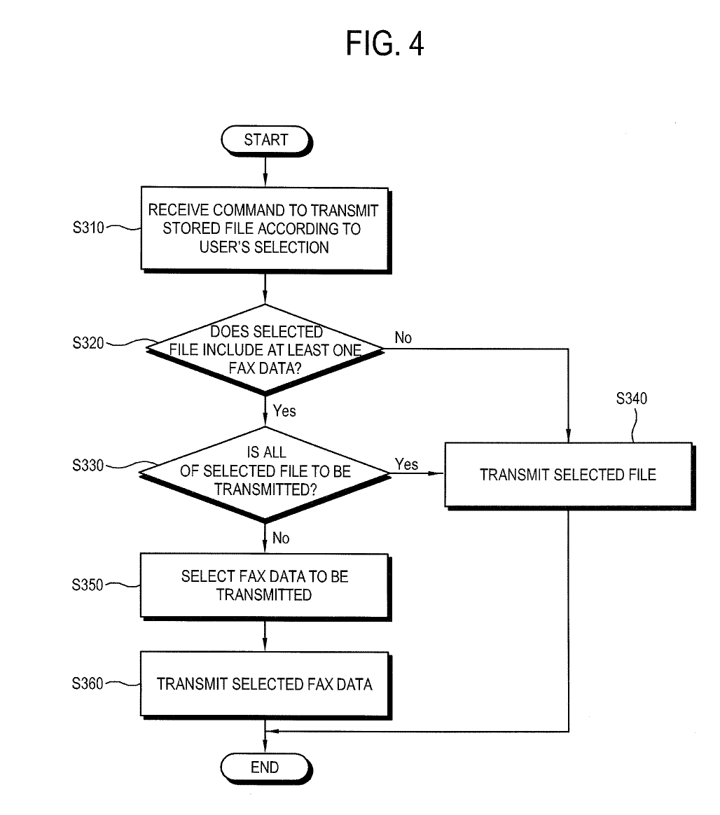

Referring to FIG. 4, the controller 170 may receive a command to transmit the stored file according to the user's selection (operation S310).

The controller 170 determines whether the file selected at operation S310 includes at least one fax data (operation S320). The controller 170 may display the selected file, the information about the fax data of the selected file, etc. through the display unit 140 or an external device connected to the fax apparatus 100.

If it is determined at operation S320 that the selected file includes at least one fax data, the controller 170 determines whether the user has selected through the user input unit 120 to transmit all, or a part, of the file (operation S330).

If it is determined at operation S330 that only part of the selected file is to transmitted, the controller 170 selects the fax data to be transmitted according to a transmission command which has input by the user through the user input unit 120 (operation S350).

If it is determined at operation S320 that the selected file does not include at least one fax data, the controller 170 controls the output unit 150 to transmit the selected file (operation S340).

If it is determined at operation S330 that all of the selected file is to be transmitted, the controller 170 controls the output unit 150 to transmit all of the selected file (operation S340).

The controller 170 controls the output unit 150 to transmit the selected fax data (operation S360).

As described above, the fax apparatus and the data management method thereof according to the present general inventive concept may manage and use a plurality of fax data more conveniently.

The fax apparatus and the data management method thereof according to the present general inventive concept may store at least one fax data as a single file according to a preset storage option of fax data and improve a user's convenience in searching data.

The fax apparatus and the data management method thereof according to the present general inventive concept may output or retransmit all, or a part, of fax data received, for example, from a particular sender or received at a particular day or time according to a preset storage option.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A data management method of a fax apparatus, the data management method, comprising:
setting a storage option of fax data;
receiving at least one fax data; and
storing at least one received fax data as a single file according to the set storage option.

2. The data management method according to claim 1, wherein the storing of the fax data as the single file comprises updating a prestored file with the received fax data.

3. The data management method according to claim 2, wherein the updating of the prestored file comprises adding the received fax data to the prestored file.

4. The data management method according to claim 2, wherein the updating of the prestored file comprises at least one of removing at least one fax data included in the prestored file and changing an order of the fax data.

5. The data management method according to claim 2, wherein the updating of the prestored file comprises updating the prestored file per page of received fax data.

6. The data management method according to claim 1, wherein the setting of the storage option comprises storing at least one fax data received from a same sender number or received at a same time, as a single file.

7. The data management method according to claim 1, wherein the setting of the storage option comprises setting a format of the stored file.

8. The data management method according to claim 1, further comprising:
displaying the stored file.

9. The data management method according to claim 1, further comprising:
printing all or a part of the fax data stored as the single file according to a user's selection.

10. The data management method according to claim 1, further comprising transmitting all or a part of the fax data stored as the single file according to a user's selection.

11. A fax apparatus, comprising:
a receiver to receive at least one fax data from a sender;
a user input unit to receive a storage option of the received fax data;
a storage unit to store the received fax data therein; and
a controller to control the storage unit to store at least one received fax data as a single file therein according to the received storage option of the received fax data.

12. The fax apparatus according to claim 11, wherein the controller updates a prestored file with the received fax data.

13. The fax apparatus according to claim 12, wherein the controller updates the prestored file by adding the received fax data thereto.

14. The fax apparatus according to claim 12, wherein the controller updates the prestored file by at least one of removing at least one fax data among the fax data included in the prestored file and changing an order of the fax data.

15. The fax apparatus according to claim 12, wherein the controller updates the prestored file per page of received fax data.

16. The fax apparatus according to claim 11, wherein the storage option comprises storage of at least one fax data received from a same sender number or received at a same time, as a single file.

17. The fax apparatus according to claim 11, wherein the storage option comprises setting a format of the stored file.

18. The fax apparatus according to claim 11, further comprising:
a display unit to display the stored file.

19. The fax apparatus according to claim 11, further comprising:
an output unit to print all or a part of the fax data stored as the single file according to a user's selection.

20. The fax apparatus according to claim 11, further comprising:
a transmitter to transmit all or a part of the fax data stored as the single file according to a user's selection.

21. A fax data management system, comprising:
a fax data receiving device to receive fax data;
an input device to preset a storage option associated with received predetermined fax data;
a controller to determine whether the received fax data is the predetermined fax data; and
a memory to store the received fax data therein in a first file according to the preset storage option if the received fax data is the predetermined fax data, and to store the received fax data therein in a second file if the received fax data is not the predetermined fax data.

22. The fax data management system of claim 21, wherein the first file is a prestored file which includes fax data of at least a first sender.

23. The fax data management system of claim 21, wherein the second file is a prestored file which includes fax data of a second sender different than the first sender.

24. The fax data management system of claim 21, further comprising:
a fax data sending unit to transmit fax data from one of the first file and second file to a predetermined receiver.

25. A method to manage fax data in a fax apparatus, the method comprising:
storing received fax data in a single file according to a preset storage option of predetermined fax data; and
outputting at least one predetermined fax data stored in the single file to a selected receiver.
